(19) United States
(12) Patent Application Publication
(10) Pub. No.: US 2014/0026065 A1
(43) Pub. Date: Jan. 23, 2014

(54) TRANSPORTATION SERVICE COMMUNICATION METHOD, APPARATUS AND SYSTEM

(71) Applicant: YINGJIE WANG, Burke, VA (US)

(72) Inventor: YINGJIE WANG, Burke, VA (US)

(21) Appl. No.: 14/038,893

(22) Filed: Sep. 27, 2013

Related U.S. Application Data
(63) Continuation of application No. 13/366,346, filed on Apr. 18, 2012, now abandoned.

(51) Int. Cl. G06F 3/0484

(52) U.S. Cl. CPC G06F 3/0484
USPC 715/744

(57) ABSTRACT

Methods, apparatus and systems for transportation service communication are provided herein. An exemplary method can be implemented by an electronic device. In the exemplary method, configuration settings can be obtained from a user. The configuration settings can be sent to a server. A map can be received from the server and displayed on the electronic device. One or more icons can be displayed on the map according to the configuration settings. The one or more icons can include one or more customer icons, one or more vehicle icons, or a combination thereof. An icon can be selected from the one or more icons to display transportation service information corresponding to the icon. The icon can represent a driver or a customer.

### CROSS-REFERENCES TO RELATED APPLICATIONS

This application claims priority to U.S. patent application Ser. No. 13/366,346, filed on Apr. 18, 2012, the entire contents of which are incorporated herein by reference.

### FIELD OF THE DISCLOSURE

The present disclosure generally relates to transportation system and location-based services and, more particularly, relates to methods, apparatus and systems for transportation service communication.

### BACKGROUND

In transportation systems such as taxi services, there are usually two methods for a customer to obtain service. In one method, the customer can stand on the street and indicate request by ‘hail’ gestures. In this case, a taxi driver usually has to keep driving on the road while looking for customers until seeing a customer hailing. Such driving not only wastes time, labor, fuel, etc., but also adds burden to road traffic and increases environmental pollution.

In the other method, the customer can contact a taxi service provider to set a location and time for a taxi, such as by phone or through a computer connected to the Internet. In this case, the taxi driver can arrive at the customer's location directly without driving on the road randomly. However, a taxi service provider needs to allocate computing, communication, and human resources specifically to establish and maintain a taxi dispatching system. The taxi dispatching system adds extra communication links between the customer and the driver. Furthermore, customer usually can only look up information of one taxi provider at a time (e.g., by browsing webpages), and cannot be provided with options of various available transportation service providers simultaneously.

Thus, there is an urgent need of methods for transportation service communication to reduce extra driving distance, ease road traffic, greatly reduce environmental pollution, thus significantly saving resources such as gas and taxi mileage. There is also an urgent need of methods for transportation service communication to eliminate or reduce the dependence on a dispatch system, improve communication efficiency, and enhance customer convenience.

### BRIEF SUMMARY OF THE DISCLOSURE

According to various embodiments, there is provided a method for transportation service communication. An exemplary method can be implemented by an electronic device. In the exemplary method, configuration settings can be obtained from a user. The configuration settings can be sent to a server. A map can be received from the server and displayed on the electronic device. One or more icons can be displayed on the map according to the configuration settings. The one or more icons include one or more customer icons, one or more vehicle icons, or a combination thereof. An icon can be selected from the one or more icons to display transportation service information corresponding to the icon. The icon can represent a driver or a customer.

According to various embodiments, there is also provided an apparatus for transportation service communication. The apparatus can include an obtaining unit, a display unit, and a selection unit. The obtaining unit can be configured to obtain configuration settings from a user and send the configuration settings to a server. The display unit can be configured to display a map received from the server. One or more icons can be displayed on the map according to the configuration settings. The one or more icons can include one or more customer icons, one or more vehicle icons, or a combination thereof. The selection unit can be configured to select an icon from the one or more icons to display transportation service information corresponding to the icon. The icon can represent a driver or a customer.

According to various embodiments, there is further provided a method for monitoring traffic condition. In an exemplary method, configuration settings can be obtained from a first user by a first electronic device. The first user can be a driver operating a vehicle. The configuration settings can include a location of the vehicle. The configuration settings can be sent to a server by the first electronic device. A map can be received from the server by a second electronic device and displayed on the second electronic device. An icon representing the vehicle can be displayed on the map according to the configuration settings. The icon can be selected on the map by the second electronic device. Transportation service information corresponding to the vehicle can be displayed to monitor the traffic condition at the location of the vehicle according to the transportation service information.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts an exemplary environment incorporating certain disclosed embodiments; and

FIG. 2 depicts an exemplary computing system consistent with the disclosed embodiments.

FIG. 3 depicts an exemplary method for transportation service communication in accordance with various disclosed embodiments;

FIGS. 4a-4b depict interfaces of obtaining configuration information in an exemplary method for transportation service communication in accordance with various disclosed embodiments;

FIGS. 5a-5b depict interfaces of displaying a map in an exemplary method for transportation service communication in accordance with various disclosed embodiments;

FIG. 6 depicts an interface of selecting an icon in an exemplary method for transportation service communication in accordance with various disclosed embodiments;

FIG. 7 depicts an exemplary apparatus for transportation service communication in accordance with various disclosed embodiments; and

FIG. 8 depicts obtaining and processing configuration settings in an exemplary method for transportation service communication in accordance with various disclosed embodiments.

### DETAILED DESCRIPTION

Reference will now be made in detail to exemplary embodiments of the disclosure, which are illustrated in the accompanying drawings.

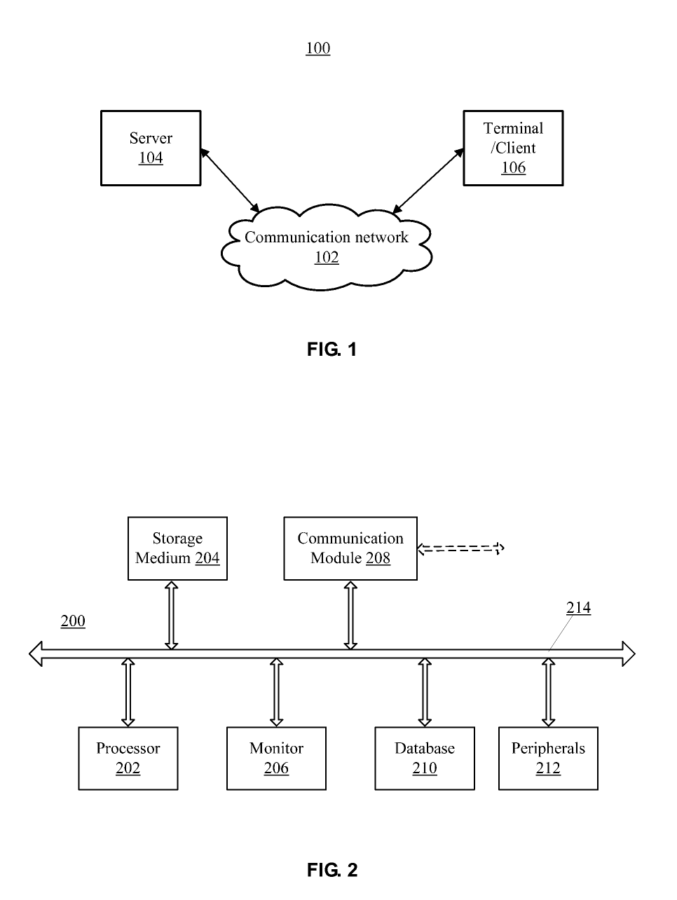

FIG. 1 depicts an exemplary environment 100 incorporating exemplary methods, apparatus and systems for transportation service communication, in accordance with various disclosed embodiments. As shown in FIG. 1, the environment 100 can include a server 104, a terminal 106, and a communication network 102. The server 104 and the terminal 106 may be coupled through the communication network 102 for information exchange, such as sending/receiving information, configuration settings, and maps, etc. Although only one terminal 106 and one server 104 are shown in the environment 100, any number of terminals 106 or servers 104 may be included, and other devices may also be included.

The communication network 102 may include any appropriate type of communication network for providing network connections to the server 104 and terminal 106 or among multiple servers 104 or terminals 106. For example, the communication network 102 may include the Internet or other types of computer networks or telecommunication networks, either wired or wireless. The communication network 102 may also be a cloud configuration.

A terminal, as used herein, may refer to any appropriate user terminal with certain computing capabilities, e.g., a personal computer (PC), a work station computer, a hand-held computing device (e.g., a tablet), a mobile terminal (e.g., a mobile phone or a smart phone), or any other user-side computing device. The terminal may have one or more clients installed, and the clients can refer to various applications or application programs. When an application is operating on the terminal, the application can establish a session for information interchange (e.g., between the terminal and the server) correspondingly.

A server, as used herein, may refer to one or more server computers configured to provide certain server functionalities, e.g., obtaining configuration settings sent by multiple terminals, data management, data processing, generating maps, etc. A server may also include one or more processors to execute computer programs in parallel.

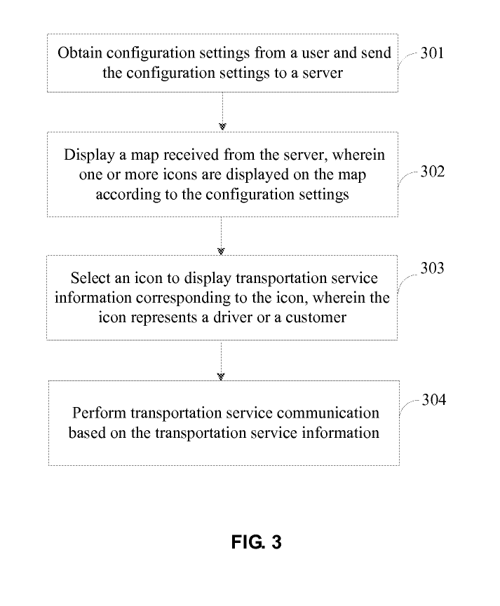

The server 104 and the terminal 106 may be implemented on any appropriate computing platform. FIG. 2 shows a block diagram of an exemplary computing system 200 capable of implementing the server 104 and/or the terminal 106. As shown in FIG. 2, the exemplary computer system 200 may include a processor 202, a storage medium 204, a monitor 206, a communication module 208, a database 210, peripherals 212, and one or more bus 214 to couple the devices together. Certain devices may be omitted and other devices may be included.

The processor 202 can include any appropriate processor or processors. Further, the processor 202 can include multiple cores for multi-thread or parallel processing. The storage medium 204 may include memory modules, e.g., Read-Only Memory (ROM), Random Access Memory (RAM), and flash memory modules, and mass storages, e.g., CD-ROM, U-disk, removable hard disk, etc. The storage medium 204 may store computer programs for implementing various processes (e.g., obtaining sensor data such as GPS receiver data, data calculations, obtaining and sending configuration settings, exchanging data between terminal and server), when executed by the processor 202.

The monitor 206 may include display devices for displaying contents in the computing system 200, e.g., displaying a map and/or an interface. For example, the display devices may include a touch screen. The peripherals 212 may include I/O devices, e.g. keyboard and/or mouse for inputting information, making selection on a monitor. The peripherals 212 may also include GPS receiver or other suitable signal receivers for determining geographic location of a terminal.

Further, the communication module 208 may include network devices for establishing connections through the communication network 102. The database 210 may include one or more databases for storing certain data and for performing certain operations on the stored data, e.g., map database, database of users' configuration settings, etc.

In operation, the terminal 106 may cause the server 104 to perform certain actions, e.g., receiving configuration settings from the terminal 106, extracting data from configuration-setting files (e.g., when the files are on the server 104), generating a map for sending to the terminal 106, updating the map using the data sent by the terminal 106, or other database operations. The server 104 may be configured to provide structures and functions for such actions and operations. More particularly, the server 104 may include a backend cloud computing platform and a mapping system for real-time map generation, updating and providing map-based services. The server 104 and the terminal 106 may have software/program (e.g. a TaxiZag application) installed to execute TaxiZag sessions in accordance with various embodiments.

In various embodiments, a terminal such as an electronic device involved in the disclosed methods and systems can include the terminal 106, while a server involved in the disclosed methods and systems can include the server 104. The disclosed methods and apparatus may be implemented by a terminal such as an electronic device (e.g., a mobile terminal). The disclosed system may be implemented by one or more terminals 106, one or more servers 104 and one or more communication networks 102. Various embodiments provide methods, apparatus and systems for transportation service communication.

Transportation service refers to any service that a driver offers by transporting a customer or goods over a certain distance. Examples of transportation service can include taxi, shuttle, goods delivery or pickup, messenger service, etc.

Transportation service communication refers to any types of communication between a customer and a driver. Communication can include, for example, the customer locating the driver and/or sending service requests to the driver, the driver locating the customer and/or sending service offers to the customer, the customer and the driver exchanging information or updates related to transportation service, etc.

A custom can refer to a person or any other applicable entity that needs to use transportation service, e.g., a person who wants to take a taxi. A customer can also refer to any other person, entity or device that can communicate on behalf of the customer.

A driver can refer to a person or any other applicable entity that operates a vehicle, e.g., a taxi driver that operates a taxi. A driver can also refer to or any other person, entity or device that is at a same location of the driver and can communicate on behalf of the driver.

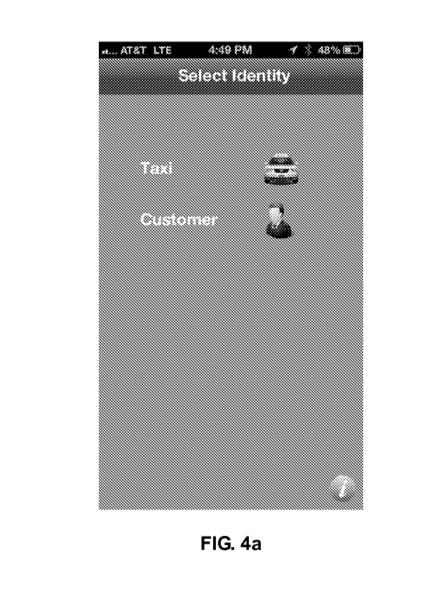

FIG. 3 depicts an exemplary method for transportation service communication in accordance with various disclosed embodiments. For illustration purposes, in one exemplary method, the transportation service can include a taxi service. In this case, a driver can refer to a taxi driver. The method can be referred to as a TaxiZag method, which can include the following steps, for example.

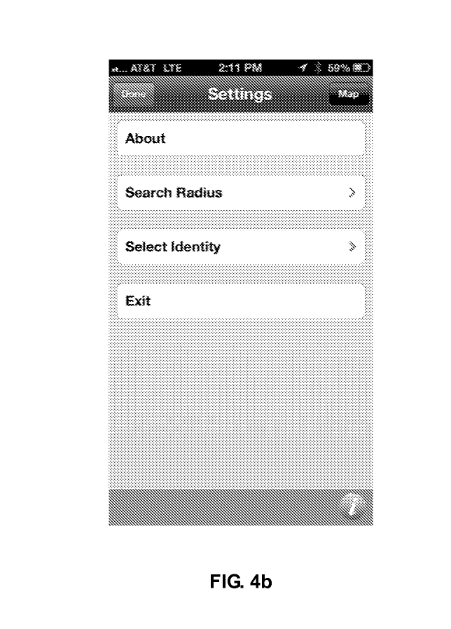

In Step 301, configuration settings of a user are obtained. As used herein, unless otherwise specified, the user refers to a person or any other applicable entity using an electronic device. FIGS. 4a-4b depict interfaces of obtaining configuration information in an exemplary method for transportation service communication in accordance with various disclosed embodiments.

When the user turns on a TaxiZag application, a TaxiZag session can be started on the electronic device, and configuration settings of the user can be obtained. Configuration settings of the user can include, for example, an identity or identifier of the user, e.g., whether the user is a customer or a driver (e.g., as shown in FIG. 4a). The configuration settings of the user can also include whether the user is available or unavailable, geographic location of the user, address of the user, contact method/information of the user, size of geographic area of interest (or search radius, e.g., as shown in FIG. 4b), etc. Depending on specific transportation service and/or purposes of communication, certain configuration settings may be required and other configuration settings may be optional, without limitation.

Configuration settings of the user may be obtained using a variety of methods. In one embodiment, the configuration settings may be stored in a configuration-setting file on the electronic device (e.g., stored during a previous TaxiZag session of the user on the electronic device), and can be obtained automatically and directly from the electronic device when a TaxiZag session starts.

In another embodiment, configuration settings are not stored beforehand, e.g., for a first-time user of the TaxiZag application on the electronic device. When the user starts the TaxiZag session, the user may be prompted to enter the configuration settings as required.

In one embodiment, attributions may be modified as needed during the TaxiZag session. Further, during the TaxiZag session, e.g., at the end of the TaxiZag session, the user may be prompted to choose whether to store the configuration settings for a future session or not.

Further, the configuration settings can include the geographic location (or location) of the user. In one embodiment, the location can include a latitude and/or a longitude of the user. The location may be obtained in various ways.

In some embodiments, the location can be provided by location data, which can be obtained automatically by the electronic device using one or more of, e.g., global positioning system (GPS)-based services, wireless local area network (WLAN)-based (or WiFi-based) services, cell transmitter-based services. For example, when a GPS receiver is embedded in the electronic device, the GPS receiver can calculate the location of the electronic device by precisely timing signals sent by GPS satellites high above the Earth. In another example, the electronic device may use certain software to obtain the location data by triangulating different mobile phone signal strengths from different cell transmitters and then using their location property (retrieved from an online cell site database). In yet another example, the location data may be calculated by discovering nearby WiFi hotspots and using their location property (retrieved from an online WiFi database), when suitable software is installed on the electronic device for such calculation functions.

When the location data is obtained automatically by the electronic device, during the TaxiZag session, the location data may be continuously updated at a certain frequency. The frequency may be determined by the method(s) used for obtaining the location. For example, the GPS receiver may update the location data at a frequency determined by the GPS satellites.

In other embodiments, the location can be inputted by the user. When inputting the configuration setting, the user may be provided with options on the methods for setting the location. When the location is inputted by the user, various inputting methods can be used. In one embodiment, the user may be allowed to specify their current location or address by touching (e.g., tapping) a location on the map. In another embodiment, the use can enter a current location by entering an address, an inter-section, a point of interest, etc., in a text box.

In one embodiment, the TaxiZag session may require the location to be obtained automatically by the electronic device instead of being inputted by the user. In this case, at an updating frequency, the electronic device may update the location in the configuration settings, using an updated location obtained from the location data. The updating frequency may be adjusted by user or by the TaxiZag application, or be fixed by the TaxiZag application, without limitation. In one embodiment, the updating frequency can be about once/3 seconds, or higher than about once/3 seconds.

The contact information can include one or more of phone number, email address, instant message service information, Voice over Internet Protocol (VoIP) service account number, etc. In one embodiment, the electronic device can be a mobile phone, and the contact information can include a phone number of the mobile phone. Whether to input the contact information, which type of contact information to input, and which contact information to display, etc., can be varied based on configuration settings of the TaxiZag session, and can be chosen by the user, without limitation.

Some of the configuration settings that the user is prompted to input can vary based on other configuration settings of the user. For example, if/when the user inputs that he/she is a customer, the TaxiZag session can enter a customer mode. In the customer mode, the customer can be prompted to input configuration settings that may be applicable to customers. For example, the configuration settings can include whether the customer is available (seeking service) or unavailable (not seeking service). In one embodiment, in the customer mode, when the TaxiZag session starts, the customer can be specified as available by default (i.e., automatically).

In the customer mode, other examples can include personal preferences, e.g., type of vehicle (make, model, size, etc.), preferred music, smoking or non-smoking, information regarding the service desired (e.g., destination address, distance, etc.). In one embodiment, the customer may have an option to input no contact information or hide all the contact information.

For example, if/when the user inputs that he/she is a driver, the TaxiZag session can enter a driver mode. In the driver mode, the customer can be prompted to input configuration settings specifically applicable to drivers. For example, the configuration settings can include whether the driver is available (vacant) or unavailable (occupied). In one embodiment, in the driver mode, when the TaxiZag session starts, the driver can be specified as available by default (i.e., automatically). In one embodiment, in the driver mode, the contact information of the driver can include a mobile phone number of the driver.

In the driver mode, other examples can include, e.g., type of vehicle (make, model, size, etc.), smoking or non-smoking, taxi company name, the driver's name, the vehicle's license plate number, etc. In one embodiment, the configuration settings can include a current speed of a vehicle's movement, and/or a direction of the vehicle's movement, etc. Configuration settings related to vehicle's movement may be obtained by the built-in GPS receiver of the electronic device, for example. Other suitable location determination methods may also be used.

Referring to FIG. 3, in Step 302, a map is displayed according to the configuration settings. Icons may be displayed on the map, and the icons can include customer icons, vehicle icons, or a combination thereof.

After the configuration settings of the user are obtained (e.g., in Step 301), the configuration settings can be sent to a TaxiZag server by the electronic device. The TaxiZag server can receive the configuration settings of the user. In addition, the TaxiZag server can also receive configuration settings of other users (via the electronic devices of those users) using a similar or same method as depicted above in accordance with various embodiments. According to the configuration settings the TaxiZag server receives, the TaxiZag server can generate a map and send the map to the electronic device(s) to be displayed. In one embodiment, the map can be displayed on a screen (e.g., a touch screen) of the electronic device in a TaxiZag interface.

In one embodiment, when the TaxiZag session starts, the configuration settings can be automatically obtained (e.g. as in Step 301) by the electronic device and automatically sent to the TaxiZag server. The map can then be generated, sent to the electronic device by the TaxiZag server to be displayed.

In another embodiment, when the user starts the TaxiZag session, the user may be prompted to input the configuration settings as required (e.g., for a first-time user). The inputted configuration settings can be obtained by the electronic device and sent to the TaxiZag server. The map can then be generated, sent to the electronic device by the TaxiZag server, and displayed.

Optionally, the configuration-setting file of the user may be stored in storage space (or memory space) on the TaxiZag server. The storage space may be allocated to the user when the user applies for an account from the TaxiZag server. In this case, when the user starts the TaxiZag session, the user may log in to the account on the TaxiZag server via the electronic device. The TaxiZag server can then open the configuration-setting file automatically, and obtain the configuration settings from the configuration-setting file.

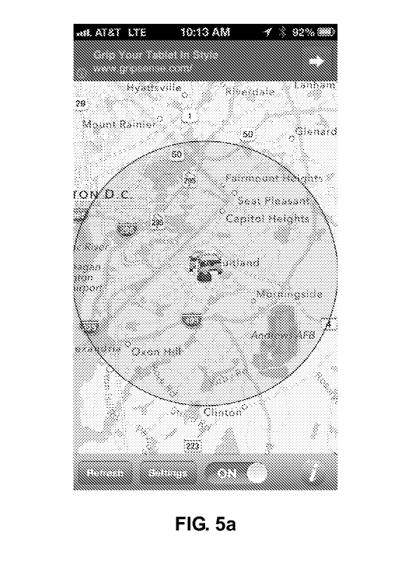

The map can be generated using map data provided to the electronic device by a network-based map service through an Application Programming Interface (API). Examples of map APIs may be the Google® Map API provided by Google Inc. (Mountain View, Calif.), OpenStreetMap (provided by OpenStreetMap Foundation of West Midlands, United Kingdom) Bing Maps (provided by Microsoft Corp. of Redmond, Wash.), etc. FIGS. 5a-5b depict interfaces of displaying a map in an exemplary method for transportation service communication in accordance with various disclosed embodiments.

The TaxiZag server may process the map, so customers and/or drivers can be shown on the map as icons (e.g., as shown in FIG. 5a). For example, each customer can be displayed as a customer icon, and each driver can be displayed as a vehicle icon (or driver icon, taxi icon). The positions of the icons on the map can correspond to the location (i.e., the geographic location) of the customer or the driver that the icon represents. The locations of the customers or drivers may be based on the configuration settings sent to the server.

Optionally, the icons may have a same or different appearance (e.g., shape, color, size, etc.). In one embodiment, a customer icon may include a human symbol and a vehicle icon may include a vehicle symbol. Icons representing an available driver, an unavailable driver, an available customer and an unavailable customer may be displayed as in green, grey, blue, and pink, respectively. Thus, icons can indicate certain configuration settings of customers and/or drivers, so users may visually distinguish various icons. Colors, shapes, sizes of the icons can be selected by the user by inputting the configuration settings, or can be selected by the TaxiZag application, without limitation.

In various embodiments, a same TaxiZag interface can be displayed regardless of whether the user is a customer or a driver. That is, drivers and customers using the TaxiZag application can use the same interface and the same map generated by the TaxiZag server. However, specific contents of the map to be displayed on each electronic device may vary based on practical needs and may be adjusted based on the configuration settings.

For example, the range of the map, i.e., the size or shape of the geographic area that the map shows, may be adjusted based on the user's configuration settings, or may be fixed by the TaxiZag server, without limitation. The position of the map, i.e., the location of the geographic area that the map shows, may be adjusted based on the user's configuration settings, or may be fixed by the TaxiZag server, without limitation. In one embodiment, the map can include a two-mile area (i.e., a circular area having a radius of about one mile) and can have the position of the user in the center of the area. In one embodiment, the radius can be selected by the user. For example, the user may be prompted to choose the radius between a minimum radius and a maximum radius.

In one embodiment, the map can have a rectangular shape. In the map, an area of certain size (e.g., a circular area having a certain radius) can be indicated on the map. In one embodiment, a blue shade and/or blue boundary can be used to indicate that the area is designated by the user, and the icons can be displayed in that area (e.g., as shown in FIGS. 5a-5b).

In one embodiment, the icons representing available customers and available drivers can be displayed on the map. However, depending on the configuration settings of the user, the map may also be shown according to the various modes.

For example, when the TaxiZag session is in the customer mode, the map may display the customer icons and the vehicle icons. The user may have an option to display the vehicle icons and the one customer icon that represents the user (e.g., when displaying the customer icons of other customers make the map appear too crowded). The user may also have an option to display only the vehicle icons, or to display only the vehicle icons that are available (i.e., the vehicle icons representing available drivers).

In another example, when the TaxiZag session is in the driver mode, the map may display customer icons and vehicle icons. The user may have an option to display the customer icons and the one vehicle icon that represents the user, (e.g., when displaying the vehicle icons of other drivers make the map appear too crowded). The user may also have an option to display the customer icons, or to display only the customer icons that are available (i.e., representing available customers).

Depending on the range and position of the map, and location of the user, there can be none, or one or more customer icons displayed in the map. Similarly, there can be none, or one or more vehicle icons displayed in the map.

Besides the map, various other elements may be displayed in the TaxiZag interface, as described in the following illustrative examples (e.g., as shown in FIGS. 5a-5b).

Further, the map may be displayed with a top banner and bottom banner. The banners can be updated using a similar or a same method as the location is updated. On the bottom banner, a name of the TaxiZag application can be displayed. For example, when the user clicks on the name of the TaxiZag application, an information page can open to display product, legal and contact information. The information page can have one button on the top to go back to the map. A “setting” button may be displayed on the TaxiZag interface. The “setting” button can be clicked to display a prompt or a series of prompts for the user to input/modify the configuration settings (e.g., as shown in FIG. 4b).

The top banner can hold an image, e.g., a jpeg graphic image or any other suitable images, animations, clips, videos, etc., which can be supplied by the TaxiZag server (e.g., used for advertising purposes).

In addition, the map can be zoomed and panned through multi-touch, suitable buttons, scale bars, tapping, dragging, sliding, or any other suitable operations.

A re-center button can be available on the map to re-center the map. For example, when the button is pressed, the map can be re-centered to the location of the user, and the map scale can be set to a predefined value. As depicted above in various disclosed embodiments, when a user starts the TaxiZag session, the map can be displayed and centered at the current location of the user.

The user interface can have a toggle button labeled “I am not available” and/or “I am available”. The user can use the toggle button in order to change availability status. The TaxiZag interface can also have an “Exit” button. The user may click the “Exit” button to terminate the TaxiZag session.

When the location is obtained automatically by the electronic device (e.g., as depicted in Step 301), during the TaxiZag session, the electronic device may continuously update the location and send the location to the TaxiZag server at the updating frequency, regardless of whether or not the configuration settings (other than the location) need to be updated or sent to the TaxiZag server. In addition, the TaxiZag server can also receive update locations of other users (via the electronic devices of those users) using a similar or same method as depicted above in accordance with various embodiments.

In one embodiment, the TaxiZag application may require the locations of multiple electronic devices (e.g., any electronic devices on which the TaxiZag session is operating) to be automatically obtained and updated. In this case, the TaxiZag sessions on the electronic devices can update the respective locations and send the locations to the TaxiZag server at the updating frequency. In one embodiment, the updating frequency can be about once/3 seconds, or less than about once/3 seconds. Therefore, at a certain frequency (e.g., at the updating frequency), the TaxiZag server can use the updated locations to update the positions of the icons in the map and send the updated map to the electronic devices to be displayed. Thus, locations of icons displayed on the map may be updated in real-time or close to be in real-time.

Because the configuration settings may contain the speed and the direction of the vehicle (e.g., when the user is a driver), the vehicle icon representing the driver may be displayed according to the speed and the direction. For example, the orientation of the vehicle icon in the map may illustrate the direction of the vehicle's movement, such as a vehicle symbol with its front facing the direction that the vehicle is moving in. For another example, the color of the vehicle may be adjusted based on the speed.

Using certain map APIs, e.g., OpenStreetMap, posted speed limits of roads may be available. Thus, for the vehicle icon, by obtaining the speed of the vehicle and the posted speed limit of the road the vehicle, the TaxiZag server may obtain a difference between the speed and the posted speed limit, thus obtaining traffic condition. For example, when the posted speed it is about 65 miles per hour (mph), while the vehicle is at about 20 mph, the difference may be larger than a threshold (which can be set by the TaxiZag, for example), and may indicate a traffic congestion situation at the location and direction of the vehicle. Based on the speed difference, the TaxiZag server may indicate traffic condition by adjusting the appearance of the icon or using other suitable indications.

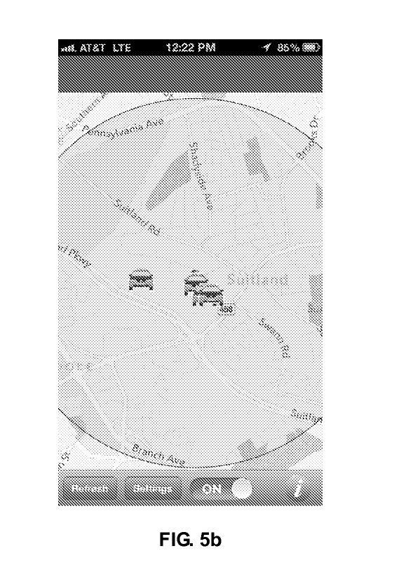

Referring to FIG. 3, in Step 303, an icon is selected to display transportation service information corresponding to the icon. For example, the selection made by the user can be received by the electronic device and sent to the server. The server can thus send the transportation service information to the electronic device to be displayed. FIG. 6 depicts an interface of selecting an icon in an exemplary method for transportation service communication in accordance with various disclosed embodiments. As used herein, wherever applicable, unless otherwise specified, the terms “transportation service information” and “information” can be used interchangeably.

The information can be based on the configuration settings. For example, when in the customer mode, the user (i.e., the customer) can select and tap a vehicle icon (a driver icon, or a taxi icon) of the vehicle icons. A popup text box or a balloon box can be displayed near the taxi icon to show the information about the driver of the vehicle and/or the vehicle, availability, taxi company name, current speed, direction, the driver's cell phone number (e.g., as shown in FIG. 6). In one embodiment, the electronic device can be mobile phone, and the customer can subsequently tap the driver's cell phone number to call the driver.

The information displayed for the icons can be determined by the configuration settings according to needs of the user(s), or by the TaxiZag server based on practical applications or purposes. In one embodiment, when in the driver mode, customer icons may be displayed but may not be touchable. That is, no contact information can be displayed about the customer icons. In another embodiment, when in the customer mode, the user (i.e., the customer) can opt to have the contact information displayed, so drivers may take the initiative to contact the user. In one embodiment, the customer may choose to have configurations related to personal preferences displayed.

In various embodiments, the TaxiZag server may obtain posted speed limits for various roads (e.g., as depicted in Step 302) and obtain the configuration settings of a first user. The first user can be a driver operating a vehicle. A vehicle icon that represents the first user can be selected by a second user (i.e., on an electronic device of the second user). In this case, the second user can be a customer or a driver, and can be different from the first user. In addition to the speed and/or the direction of the vehicle, the popup text box may display the posted speed limit at the location of the vehicle. The text box may display the difference between the posted speed limit and the speed of the vehicle. Such information may indicate to the second user whether there is a traffic congestion at the location of the vehicle.

In one embodiment, the second user may know or estimate the posted speed limit by being familiar with the road of interest. For example, the second user can recognize a highway in the map, which can have a speed limit of more than about 55 mph, according to the second user's knowledge. When a selected vehicle icon shows a speed of less than about 20 mph in one direction, the speed can indicate a traffic congestion so the second user may avoid a route that involves that highway in that direction.

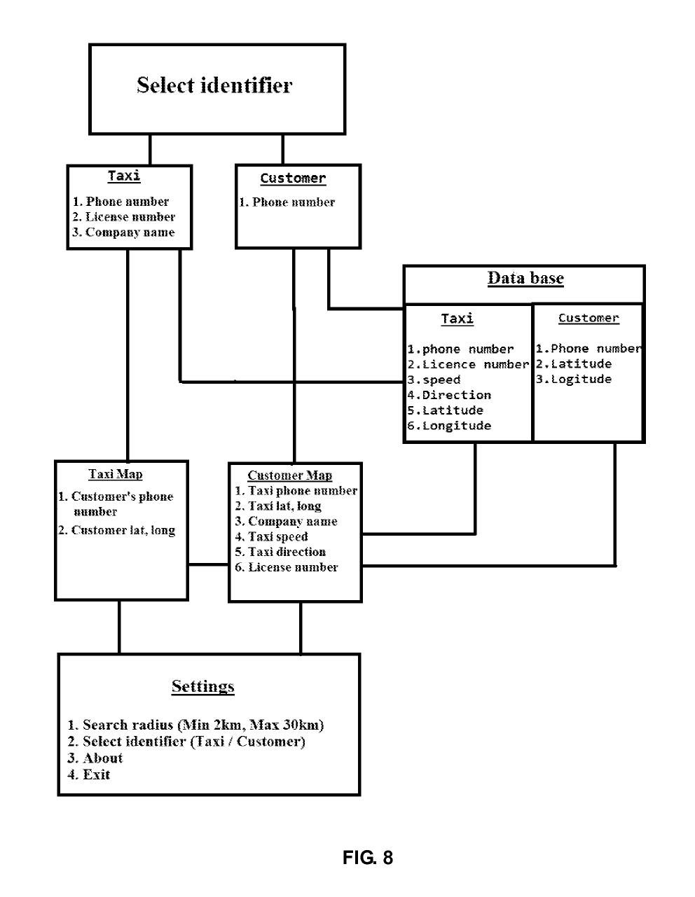

Processing the configuration settings and displaying the transportation service information can be further detailed in an example as follows. FIG. 8 depicts obtaining and processing configuration settings in an exemplary method for transportation service communication in accordance with various disclosed embodiments.

In the example as shown in FIG. 8, in the driver mode, the identifier or identity of the user can be a taxi (i.e., a driver). The configuration settings (as shown in the box ‘Taxi’) can be obtained, and sent to a database (e.g., as shown in the box ‘Data base’). Similarly, in the customer mode, the identifier or identity of the user can be a customer. The configuration settings (as shown in the box ‘Customer’) can be obtained, and sent to the database. In various embodiments, the database can be managed by the TaxiZag server.

In the driver mode, the map displayed on the electronic device can be a Taxi Map. When an icon on the map is selected (e.g., a customer icon), the TaxiZag server can extract information from the corresponding configuration settings in the database. The information can then be received by the electronic device and displayed on the Taxi Map (e.g., as shown in the box ‘Taxi Map’). In the customer mode, the map displayed on the electronic device can be a Customer Map. When an icon on the map is displayed (e.g., a driver icon, or a taxi icon), the TaxiZag server can extract information from the corresponding configuration settings in the database. The information can then be received by the electronic device and displayed on the Customer Map (e.g., as shown in the box ‘Customer Map’).

In both the driver mode and the customer mode, configuration settings can be modified, e.g., as shown in the box ‘Settings’. The configuration settings and information in FIG. 8 are only for illustrative purposes, and are not limited in the present disclosure.

Referring to FIG. 3, in Step 304, optionally, transportation service communication is performed based on the information. After viewing the information displayed (e.g., as described in Step 303), the user may make a choice to perform the transportation service communication by using the information.

In one embodiment, in the customer mode, the user may send a request for transportation service corresponding to one of the vehicle icons. For example, the user may choose to request a taxi ride from the driver represented by the vehicle icon. In one embodiment, the electronic device can be a mobile phone. The user may find the driver's cell phone number displayed in the popup box, and tap on the cell phone number to call the driver.

In another embodiment, in the driver mode, the user may send an offer of transportation service corresponding to one of the customer icons. For example, the user may choose to offer a taxi ride to the customer represented by the customer icon. The user may find the customer's cell phone number displayed in the popup box, and tap on the cell phone number to call the customer.

Various methods may be used for transportation service communication. Depending on the configuration settings, in addition to calling cell phones, other methods can also be used, e.g., text messages, VoIP, email. The communication can be performed using the electronic device, or using other suitable methods.

In one embodiment, in the driver mode, the user (i.e., the driver) may find one or more customer icons in one location. The driver may choose to drive the vehicle to the location where one or more available customers represented by the customer icons may be seeking taxi service. The customers may be visible at a side of a street. The driver may then communicate verbally or gesture to offer taxi service to the customers.

According to various disclosed embodiments, a method for transportation service communication is provided. In an exemplary method, configuration settings of a user can be obtained. The configuration settings can include whether the user is a customer or a driver. The configuration settings are sent to a TaxiZag server. The TaxiZag server can receive the configuration settings of the user. The TaxiZag server can generate a map according to the configuration settings of the user. The map can be displayed a map according to the configuration settings. Icons can be displayed in the map. The icons can include customer icons and/or vehicle icons. An icon can be selected from the icons in the map. Information corresponding to the icon can be displayed. For example, when the user is a customer, the user may view information correspond to a vehicle icon. When the user is a driver, the user may view information correspond to a customer icon.

Optionally, based on the information, the user may choose to perform transportation service communication based on the information. For example, when the user is the customer, the user can send a request for transportation service corresponding to one of the vehicle icons (e.g., by calling the driver that the vehicle icon represents). When the user is the driver, the user can send an offer of transportation service corresponding to one of the customer icons (e.g., by calling the customer that the customer icon represents).

In various embodiments, the disclosed methods (TaxiZag methods) can creatively and intelligently bring together customers looking to take taxis and taxi drivers wanting to pick up customers. The TaxiZag methods, which can be used by the taxi drivers and the taxi customers, can display available taxis and prospective customers on a map.

For example, by using the TaxiZag method, after dropping off a previous customer, the taxi driver can find a place to park, and wait for a call from a new customer, or take the initiative to find a customer. The taxi driver does not have to keep driving on the road to look for customers. Thus, burden on road traffic can be eased, environmental pollution can be greatly reduced, and resources such as gas and taxi mileage can be significantly saved. In addition, the taxi driver may obtain the customer's location through communicating with the customer and also subsequently view the customer's location on the map to be better informed of the location. The method can help taxi drivers to save energy, reduce idle time, increase amount of customers, and then increase revenue.

In addition, using the application, a taxi customer can save time in getting a taxi. Dependence on a transportation service dispatching system can be eliminated or reduced. Further, after reserving a taxi using the TaxiZag method, because the map can display updated location of the taxi, the customer can monitor the location of the taxi in real-time while waiting for the taxi. So the customer can be well-prepared when the taxi approaches. The customer may also know the license plate number of the taxi beforehand. Thus, when the taxi is in high demand, the customer can find the taxi earlier than other more aggressive customers and approach the taxi more easily.

In various embodiments users of electronic devices (e.g., mobile phones) can get an available taxi with the highest efficiency and the shortest possible time. The most effective direct communication can thus be introduced and employed between a taxi customer and taxi driver. The TaxiZag can also solve a practical problem of difficulties in getting a taxi in the shifting time period of taxi drivers. Additionally, taxi drivers and customers can use the application to view the traffic condition ahead and adjust route at any time.

Further, in various disclosed embodiments, a method for monitoring traffic condition is provided. In an exemplary method, configuration settings of a first user can be obtained. The first user can be a driver driving in a vehicle. The configuration settings can include a location, a speed and a direction of the vehicle. The configuration settings can be sent to a TaxiZag server. The TaxiZag server can receive the configuration settings of the first user. The TaxiZag server can generate a map according to the configuration settings of the first user. Icons can be displayed in the map. The icons can include a vehicle icon representing the first user. The TaxiZag server can obtain a posted speed limit at the location and the direction of the vehicle. Based on the posted speed limit and the speed of the vehicle, the vehicle icon corresponding to the vehicle can be displayed to indicate traffic conditions, e.g., by an appearance of the vehicle icon or by displaying a message on the TaxiZag interface or other suitable methods. The TaxiZag server can send the map to a second user. The map can be displayed to the second user according to the configuration settings. The second user may monitor traffic condition by viewing the map.

Optionally, the vehicle icon can be selected from the icons in the map by the second user on an electronic device of the second user. Information corresponding to the icon can be displayed. The information may include the posted speed and the speed of the vehicle. The second user may use the information to monitor traffic condition at the location and in the direction of the vehicle.

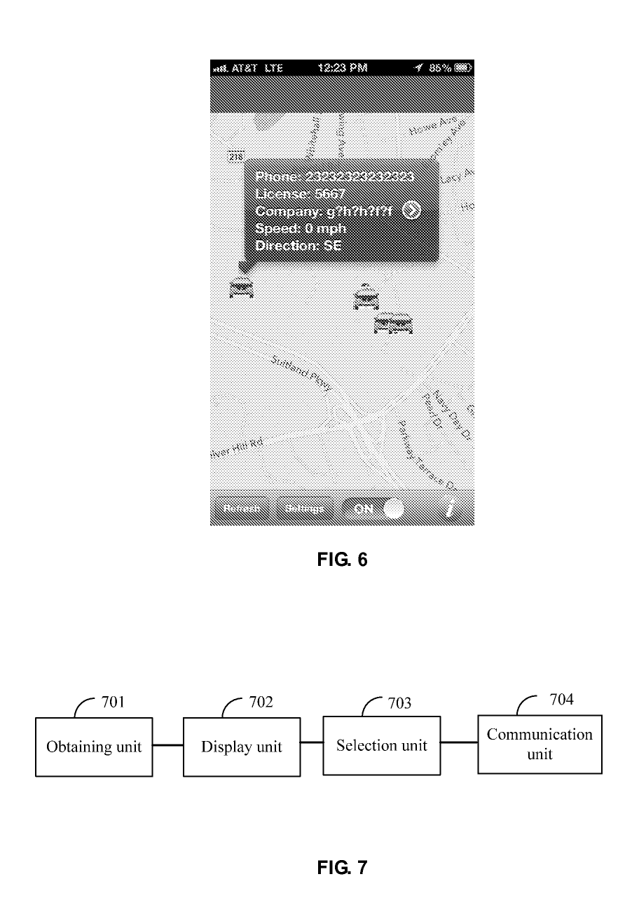

FIG. 7 depicts an exemplary apparatus for transportation service communication in accordance with various disclosed embodiments. The apparatus may be installed in a terminal, e.g., an electronic device. The apparatus may also be used as an apparatus for monitoring traffic conditions. The apparatus can include an obtaining unit 701, a display unit 702, an optional selection unit 703, and an optional communication unit 704. Some units may be omitted and other units may be included.

The obtaining unit 701 is configured to obtain configuration settings of a user. In one embodiment, the obtaining unit 701 can obtain the configuration settings from a configuration-setting file on the configuration-setting file on the electronic device. In another embodiment, the obtaining unit 701 may obtain the configuration settings by prompting the user to input the configuration settings.

The obtaining unit 701 can be further configured to send the configuration settings to a TaxiZag server. In one embodiment, the configuration-setting file of the user may be stored in storage space (or memory space) on the TaxiZag server. In this case, when the user starts the TaxiZag session, the obtaining unit 701 can be configured to log the user in to an account on the TaxiZag server. The TaxiZag server can then open the configuration-setting file automatically, and obtain the configuration settings from the configuration-setting file.

The TaxiZag server can obtain the configuration settings of other users using the similar or the same methods as disclosed above in accordance with various embodiments.

The display unit 702 is configured to receive a map generated by the TaxiZag server and display the map on the electronic device according to the configuration settings. Icons can be displayed in the map. Based on the configuration settings, and based on post speed limits provided by the TaxiZag server, the display unit 702 can be configured to display the icons to indicate traffic condition, e.g., by adjusting appearance of the icons, and/or by displaying messages on the TaxiZag interface adjacent to one or more of the icons.

The selection unit 703 is configured to display information corresponding to one of the icons when the user selects the icon. For example, the selection unit 703 can be notified of the icon the user selects, obtain the information of the icon from the TaxiZag server, and send the information to the display unit 702 for displaying. Among the information, the selection unit 703 can be further configured to display the posted speed limit at a location and direction corresponding to the selected icon, in addition to the speed of the a driver that the icon represents. Thus the user may monitor the traffic condition based on the information.

The communication unit 704 is configured to establish transportation service communication. Thus, the user may perform transportation service communication with another user represented by the icon, according to the information displayed.

The units as depicted above may be implemented using the methods as described in accordance with various embodiments.

Accordingly, various embodiments also provide a transportation service communication system (or TaxiZag system). The TaxiZag system can be used as an intelligent transportation system. The communication system can also be used as a communication system for monitoring traffic conditions. The communication system can include the apparatus for transportation service communication in accordance with various disclosed embodiments.

The communication system may further include a server, or a TaxiZag server. For example, the TaxiZag server can be configured to receive configuration settings of a user. Further, the TaxiZag server is configured to receive configuration settings of multiple users. Yet further, the TaxiZag server is configured to generate a map using the configuration settings and send the map to the electronic devices of the users. The map can have icons displayed therein. When the user selects an icon, the TaxiZag server is configured to provide information corresponding to the icon so the information can be displayed on the electronic device of the user.

The implementation of each of the above devices can be similar to or the same as exemplary methods depicted above in accordance with various embodiments.

As disclosed herein, the disclosed methods and apparatus may be accomplished by other means. The electronic devices as depicted above in accordance with various embodiments are exemplary only. For example, the disclosed units can be divided based on logic functions. In actual implementation, other dividing methods can be used. For instance, multiple units can be combined or integrated into another system, or some characteristics can be omitted or not executed, etc.

In addition, each functional unit in various disclosed embodiments can be integrated in a processing unit, or each unit can exist separately and physically, or two or more units can be integrated in one unit. The apparatus as disclosed above can be implemented in the form of hardware and/or in the form of software functional unit(s).

In various embodiments, one or more or all of the steps in each of the exemplary methods herein can be accomplished using a program/software to instruct related hardware. Such program/software can be stored in a non-transitory computer readable storage medium including, e.g., ROM/RAM, magnetic disk, optical disk, etc.

In various embodiments, the TaxiZag application can include program/software components, hardware components, or a combination of software and hardware components. The hardware components may be implemented by a part or whole of the computing systems as disclosed in accordance with various embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A method for transportation service communication, implemented by an electronic device, comprising:
obtaining configuration settings from a user;
sending the configuration settings to a server;
displaying a map received from the server, wherein one or more icons are displayed on the map according to the configuration settings, and the one or more icons include one or more customer icons, one or more vehicle icons, or a combination thereof; and
selecting an icon from the one or more icons to display transportation service information corresponding to the icon, wherein the icon represents a driver or a customer.

2. The method according to claim 1, further including:
performing the transportation service communication based on the transportation service information, wherein:
when the icon represents the driver, the user communicates directly with the driver to request a transportation service; and
when the icon represents the customer, the user communicates directly with the customer to offer the transportation service.

3. The method according to claim 1, wherein the configuration settings include a location of the user.

4. The method according to claim 3, wherein the configuration settings further include an identity of the user, whether the user is available or unavailable, or a combination thereof.

5. The method according to claim 3, wherein the obtaining of the configuration settings includes:
obtaining the location by a global positioning system (GPS) receiver of the electronic device; and
updating the location at an updating frequency.

6. The method according to claim 5, wherein the updating frequency is equal to or greater than about once per 3 seconds.

7. The method according to claim 1, wherein appearances of the one or more icons are based on the configuration settings of users represented by the one or more icons.

8. The method according to claim 1, wherein, when the icon represents the driver, the transportation service information includes a taxi company name, a name of the driver, a contact method, a license plate number, a speed, a direction, or a combination thereof.

9. An apparatus for transportation service communication, comprising:
an obtaining unit configured to obtain configuration settings from a user and send the configuration settings to a server;
a display unit configured to display a map received from the server, wherein one or more icons are displayed on the map according to the configuration settings, and the one or more icons include one or more customer icons, one or more vehicle icons, or a combination thereof; and
a selection unit configured to select an icon from the one or more icons to display transportation service information corresponding to the icon, wherein the icon represents a driver or a customer.

10. The apparatus according to claim 9, further including:
a communication unit configured to perform the transportation service communication based on the transportation service information, wherein
when the icon represents the driver, the user communicates directly with the driver to request a transportation service; and
when the icon represents the customer, the user communicates directly with the customer to offer the transportation service.

11. The apparatus according to claim 9, wherein the configuration settings include a location of the user.

12. The apparatus according to claim 11, wherein the configuration settings further include an identity of the user, whether the user is available or unavailable, or a combination thereof.

13. The apparatus according to claim 11, wherein the obtaining unit is further configured to:
obtain the location by a GPS receiver of the electronic device; and
update the location at an updating frequency.

14. The apparatus according to claim 13, wherein the updating frequency is equal to or greater than about once per 3 seconds.

15. The apparatus according to claim 9, wherein appearances of the one or more icons are based on the configuration settings of users represented by the one or more icons.

16. The apparatus according to claim 9, wherein, when the icon represents the driver, the transportation service information includes a taxi company name, a name of the driver, a contact method, a license plate number, a speed, a direction, or a combination thereof.

17. A system for transportation service communication comprising the apparatus according to claim 9.

18. A method for monitoring traffic condition, comprising:
obtaining, by a first electronic device, configuration settings from a first user, wherein the first user is a driver operating a vehicle and the configuration settings include a location of the vehicle;
sending, by the first electronic device, the configuration settings to a server;
displaying, by a second electronic device, a map received from the server, wherein an icon representing the vehicle is displayed on the map according to the configuration settings; and
selecting, by the second electronic device, the icon on the map to display transportation service information corresponding to the vehicle, to monitor the traffic condition at the location of the vehicle according to the transportation service information.

19. The method according to claim 18, wherein the transportation service information includes the speed of the vehicle.

20. The method according to claim 18, wherein the transportation service information includes a speed limit at the location of the vehicle.
